(19) United States
(12) Patent Application Publication
(10) Pub. No.: US 2026/0360135 A1
(43) Pub. Date: Nov. 12, 2026

(54) A Computer-Implemented Method of Generating Training Data for Training a Machine Learning Model

(71) Applicant: Oxa Autonomy Ltd, Oxford (GB)

(72) Inventor: Tarlan Suleymanov, Oxford (GB)

(73) Assignee: Oxa Autonomy Ltd, Oxford (GB)

(21) Appl. No.: 18/997,499

(22) PCT Filed: Jun. 23, 2023
(86) PCT No.: PCT/GB2023/051650

§ 371 Date: Jan. 21, 2025

(30) Foreign Application Priority Data
Jul. 22, 2022 (GB) 2210759.3

(51) Int. Cl. G06V 10/82; G06N 3/0464; G06N 3/08; G06V 20/56

(52) U.S. Cl. CPC G06V 10/82; G06N 3/0464; G06N 3/08; G06V 20/588

(57) ABSTRACT

According to the present invention, there is provided a computer-implemented method of generating training data for training a machine learning model to detect automatically a lane boundary from an image of a route traversed by an autonomous vehicle the computer-implemented method comprising: obtaining an image captured by an autonomous vehicle during a traversal of the route; projecting a lane boundary model, from a three-dimensional LiDAR point cloud of the route, on to the image; and generating a training data example for training the machine learning model by removing automatically one or more sections of the lane boundary corresponding to one or more respective occlusions in the image.

### FIELD

The subject-matter of the present disclosure relates to a computer-implemented method of generating training data for training a machine learning model to detect automatically a lane boundary from an image of a route traversed by an autonomous vehicle, a computer-implemented method of training a machine learning model to detect automatically a lane boundary from an image of a route traversed by an autonomous vehicle, and a transitory or non-transitory computer-readable medium.

### BACKGROUND

An autonomous vehicle (AV) may use various sensors to navigate a route. For example, the AV may navigate a route with the help of images captured by the AV. It is important for the AV to understand where lane boundaries are along the route so as to navigate the route appropriately.

Use of a machine learning model can help inference of lane boundaries using real-time images. However, training of a machine learning model for this purpose currently requires training using manual annotation of copious training examples of previous traversals of the route. This is because it is difficult to automate lane boundary generation taking other objections into account, where those objects occlude various sections of the lane boundary.

It is an aim of the subject-matter of the present disclosure to improve on the prior art by alleviating such issues.

### SUMMARY

According to an aspect of the present disclosure, there is provided a computer-implemented method of generating training data for training a machine learning model to detect automatically a lane boundary from an image of a route traversed by an autonomous vehicle, the computer-implemented method comprising: obtaining an image captured by an autonomous vehicle during a traversal of the route; projecting a model of a lane boundary, from a three-dimensional LiDAR point cloud of the route, on to the image; and generating a training data example for training the machine learning model by removing automatically one or more sections of the lane boundary corresponding to one or more respective occlusions from the image.

By removing one or more sections of the lane boundary automatically, the time to train the machine learning model is reduced significantly and the machine learning model can be extended to different areas and along new routes.

Training the machine learning model to detect automatically a lane boundary from an image of a route traversed by an autonomous vehicle may mean detecting automatically an occlusionless lane boundary, or a lane boundary without occlusions, or a lane boundary with one or more occluded sections removed, from the image of the route traversed by the autonomous vehicle. The term “occlusion” may be used herein to mean any section of the lane boundary that is not visible due to being concealed or obscured by another feature along the route. Examples of such features include other vehicles, road works, puddles, etc.

The term lane boundary may be used herein to define an interface between a region where the AV is able to travel and a region where the AV is not able to travel. The interface may be structural, e.g. a curb between a road and a sidewalk/pavement. The interface may also be non-structural, e.g. a lane marking on a road.

In an embodiment, the removing automatically one or more sections of the lane boundary may comprise: generating a free space model, using a further machine learning model, from the image, wherein the free space model includes one or more free space regions and one or more occluded regions; deleting one or more sections of the lane boundary overlapping the one or more occluded regions; and retaining one or more sections of the lane boundary overlapping the one or more free space regions.

In an embodiment, the computer-implemented method may further comprise: generating a ground truth including the retained one or more sections of the lane boundary.

In an embodiment, the further machine learning model may comprise a neural network.

In an embodiment, the neural network may be a convolutional neural network.

In an embodiment, the computer-implemented method may further comprise: obtaining a new image captured by an autonomous vehicle during a different traversal of the route; and performing inference, using the machine learning model, on the new image to determine a new lane boundary.

The determined lane boundary may be an occlusionless lane boundary, or a lane boundary without occlusions.

In an embodiment, the computer-implemented method may further comprise: comparing the new lane boundary to the ground truth; and determining an accuracy score of the new lane boundary based on the comparison.

In an embodiment, the determining the accuracy score may be determined as one or more of: a precision score based on the comparison; and/or a recall score based on the comparison; and/or an f1 score based on the comparison.

In an embodiment, the computer-implemented method may further comprise: determining that the machine learning mode is accurate if the accuracy score is greater than or equal to an accuracy threshold; and determining that the machine learning model is not accurate if the accuracy score is less than the accuracy threshold.

In an embodiment, when the machine learning model is determined not to be accurate, the computer-implemented method may further comprise: repeating, using the new image as the image, the: projecting the lane boundary model, from the three-dimensional LiDAR point cloud of the route, on to the image; and generating a training data example for training the machine learning model by removing automatically one or more sections of the lane boundary corresponding to one or more respective occlusions in the image.

In an embodiment, the computer-implemented method may further comprise: obtaining, by the autonomous vehicle, a plurality of LiDAR points of the route; and integrating the plurality of LiDAR points to generate a three-dimensional point cloud of the route.

In an embodiment, the plurality of LiDAR points and the image are paired.

In an embodiment, the computer-implemented method may further comprise: identifying, using the machine learning algorithm, a lane boundary from the captured image; constructing a three-dimensional point cloud of the lane boundary by selecting a plurality of points that correspond positionally to the identified lane boundary from the integrated three-dimensional point cloud; clustering a plurality of points from three-dimensional point cloud of the lane boundary into one or more clusters using a distance between points; and constructing a spline or best fit for each cluster as the lane boundary model.

In an embodiment, the distance between points may be calculated by: determining a distance between each point and each respective adjacent point; and clustering the plurality of points into the cluster if the respective distance is less than a distance threshold.

In an embodiment, the distance threshold may be weighted according to a direction to the respective adjacent point.

In an embodiment, the distance threshold may be weighted to increase towards a first direction and decrease towards a second direction, wherein the first direction is parallel to the direction of travel of the autonomous vehicle and the second direction is perpendicular to the direction of travel of the autonomous vehicle.

In an embodiment, the selecting the plurality of points may comprise: iteratively selecting a random set of points from the plurality of points in the cluster; constructing a spline of best fit for each iteratively selected set; calculating, for each set, a distance of the spline of best fit, to each point in the set; and selecting a spline of best fit with the smallest distance as the spline of best fit for the cluster.

In an embodiment, the distance may be an aggregate distance.

In an embodiment, the distance may be a mean distance.

In an embodiment, the machine learning model may comprise a neural network.

In an embodiment, the neural network may be a convolutional neural network.

According to an aspect of the present disclosure, there is provided a computer-implemented method of training a machine learning model to detect automatically a lane boundary from an image of a route traversed by an autonomous vehicle, the computer-implemented method comprising: providing a plurality of training data examples of images of a route traversed by an autonomous vehicle, wherein each image includes a lane boundary; providing a plurality of occlusionless lane boundary models matching the lane boundary from the image; and training the machine learning model to detect automatically an occlusionless lane boundary from an image of a route traversed by an autonomous vehicle.

In an embodiment, the obtaining the plurality of training data examples comprises the foregoing computer-implemented method.

According to an aspect of the present disclosure, there is provided a computer-implemented method of determining a trajectory for an autonomous vehicle to traverse without crossing a detected lane boundary of a route, the method comprising: capturing an image of a route; inferring, using a machine learning model, a lane boundary in the image; determining a trajectory for the autonomous vehicle to travel along the route without crossing the inferred lane boundary; and controlling the autonomous vehicle to travel along the trajectory.

In an embodiment, the machine learning model is the machine learning model from the preceding aspects and embodiments.

According to an aspect of the present disclosure, there is provided a transitory or non-transitory computer-readable medium, including instructions stored thereon that when executed by a processor, cause the processor to perform the method of any preceding claim.

According to an aspect of the present disclosure, there is provided an autonomous vehicle comprising the non-transitory computer-readable medium.

### BRIEF DESCRIPTION OF DRAWINGS

The subject-matter of the present disclosure is best described with reference to the accompanying figures, in which:

FIG. 1 shows a schematic view of an AV according to one or more embodiments;

FIG. 2 shows a flow chart outlining a computer-implemented method of generating training data for training a machine learning model to detect automatically a lane boundary from an image of a route traversed by an autonomous vehicle, according to one or more embodiments, and a computer-implemented method of training a machine learning model to detect automatically a lane boundary from an image of a route traversed by an autonomous vehicle, according to one or more embodiments;

FIG. 3 shows a three-dimensional LiDAR point cloud of a route captured by the AV from FIG. 1;

FIG. 4 shows the three-dimensional LiDAR point cloud from FIG. 3 overlayed with an image captured by the AV;

FIG. 5 shows a similar view to FIG. 4 of a three-dimensional LiDAR point cloud overlayed with an image captured by the AV, wherein the image is of a different route to FIG. 4;

FIG. 6 shows the three-dimensional LiDAR point cloud from FIG. 4 with points corresponding to lane boundaries from the image highlighted;

FIG. 7 shows a similar view to FIG. 6 for the different route from FIG. 5;

FIG. 8 shows a three-dimensional LiDAR point cloud of the lane boundary from the route from FIG. 4;

FIG. 9 shows a similar view to FIG. 8 for the lane boundary from the route from FIG. 5;

FIG. 10 shows images representing generation of a free space model;

FIG. 11 shows a flow chart detailing steps of a computer-implemented method of generating training data for training a machine learning model to detect automatically a lane boundary from an image of a route traversed by an autonomous vehicle, according to one or more embodiments;

FIG. 12 shows a flow chart detailing steps of a computer-implemented method of training a machine learning model to detect automatically a lane boundary from an image of a route traversed by an autonomous vehicle, according to one or more embodiments; and

FIG. 13 shows a flow chart detailing steps of a computer-implemented method of inferring a lane boundary in an image using a machine learning model to determine a trajectory for an AV to traverse to avoid crossing the lane boundary, according to one or more embodiments.

### DESCRIPTION OF EMBODIMENTS

The embodiments described herein are embodied as sets of instructions stored as electronic data in one or more storage media. Specifically, the instructions may be provided on a transitory or non-transitory computer-readable media. When executed by the processor, the processor is configured to perform the various methods described in the following embodiments. In this way, the methods may be computer-implemented methods. In particular, the processor and a storage including the instructions may be incorporated into a vehicle. The vehicle may be an AV.

Whilst the following embodiments provide specific illustrative examples, those illustrative examples should not be taken as limiting, and the scope of protection is defined by the claims. Features from specific embodiments may be used in combination with features from other embodiments without extending the subject-matter beyond the content of the present disclosure.

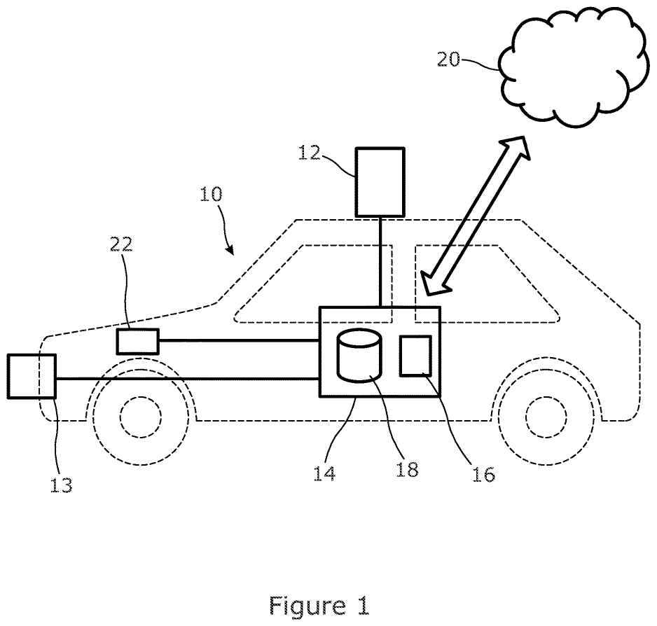

With reference to FIG. 1, an AV 10 may include a plurality of sensors 12, 13. The sensors 12 may be mounted on a roof of the AV 10. The sensors 13 may be mounted on a front of the AV 10, its front grill. The sensors 12, 13 may be communicatively connected to a computer 14. The computer 14 may be onboard the AV 10. The computer 14 may include a processor 16 and a memory 18. The memory may include the non-transitory computer-readable media described above. Alternatively, the non-transitory computer-readable media may be located remotely and may be communicatively linked to the computer 14 via the cloud 20. The computer 14 may be communicatively linked to one or more actuators 22 for control thereof to move the AV 10. The actuators may include, for example, a motor, a braking system, a power steering system, etc.

The sensors 12, 13 may include various sensor types. Examples of sensor types include LIDAR sensors, RADAR sensors, and cameras. Each sensor type may be referred to as a sensor modality. Each sensor type may record data associated with the sensor modality. For example, the LiDAR sensor may record LIDAR modality data. When the sensors 13 are mounted on a front of the AV 10 they may comprise RADAR sensors because it is easier to detect features such as lane boundaries behind certain occlusions, e.g. vehicles when mounted close to the ground.

The data may capture various scenes that the AV 10 encounters. For example, a scene may be a visible scene around the AV 10 and may include roads, buildings, weather, objects (e.g. other vehicles, pedestrians, animals, etc.), etc.

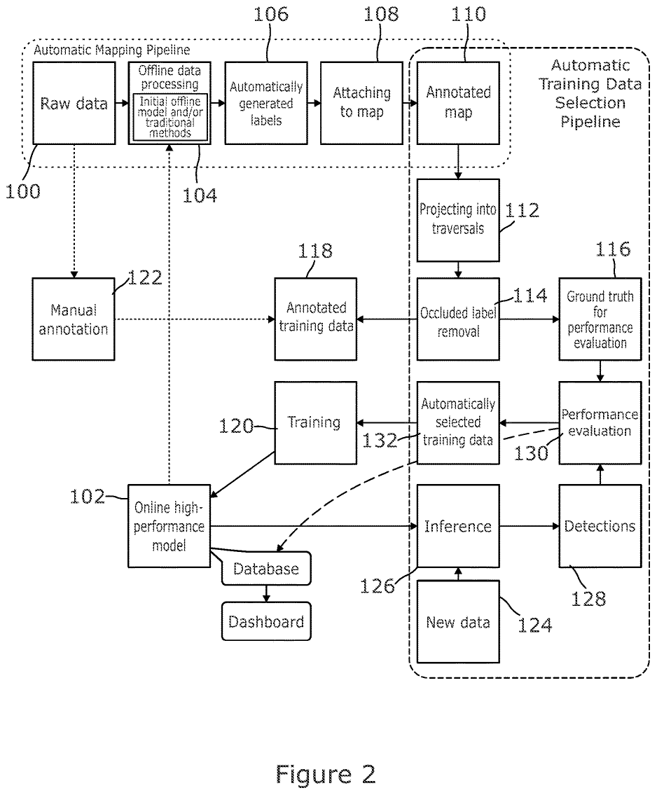

With reference to FIG. 2, according to one or more embodiments, there is provided a computer-implemented method of training a machine learning model to detect automatically a lane boundary from an image of a route traversed by an AV. As part of the method, there may be provided a computer-implemented method of generating a lane boundary model.

To generate the three-dimensional LIDAR point cloud of the route, the method may comprise at step 100, obtaining a plurality of LiDAR points of a route that the AV 10 is traveling along. Step 100 may also include obtaining an image, or a plurality of images, of the same route. The images may be captured by the roof mounted sensors 12, in the form of one or more cameras. The LiDAR points may be captured by the sensor 13, in the form of a LIDAR sensor. The LiDAR sensor 13 mounted on the front of the AV 10 enables the LiDAR beams to pass under certain objects, e.g. parked vehicles that may be occluding a lane boundary. The LiDAR points and the images may be paired. In other words, LiDAR points and images captured by the AV 10 may be synchronised because they are linked to the same system clock of the computer 14.

There is provided a machine learning model at 102. The machine learning model may comprise a neural network. The neural network may be a convolutional neural network. The machine learning model may be trained to detect automatically a lane boundary from an image of a route traversed by an autonomous vehicle. Initially, the machine learning model is trained using manually labelled training data of images with manual labels representing lane boundaries along a route within the images, as described below.

At step 104, the method comprises identifying a lane boundary, or a plurality of lane boundaries, within one or more images captured at step 100, using the machine learning model. The lane boundaries are stored as automatically generated labels as shown at 106.

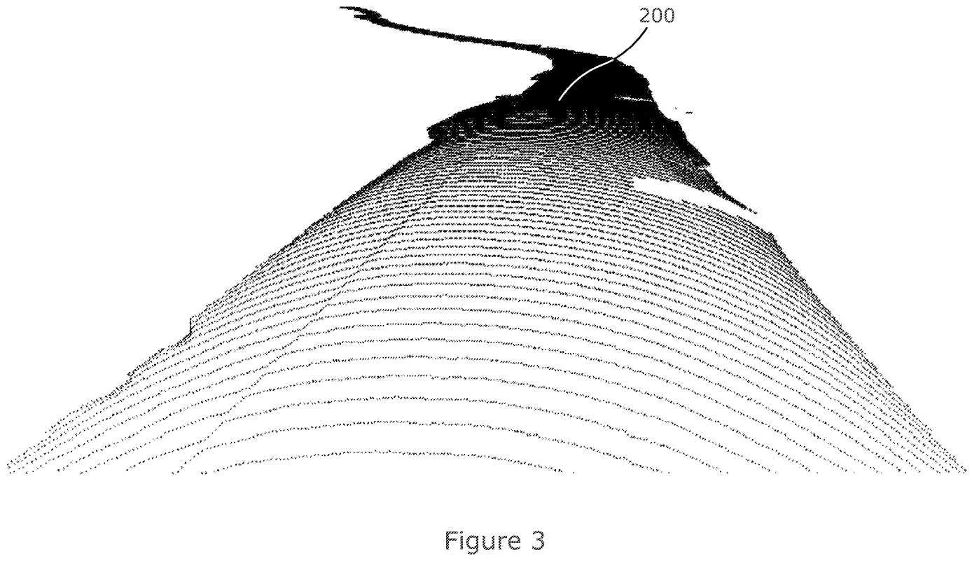

With brief reference to FIG. 3, the plurality of LiDAR points may be integrated to form a three-dimensional LiDAR point cloud of the route 200.

With further reference to FIG. 2, at step 108, the three-dimensional LiDAR point cloud of the route 200 is annotated at 108 to render an annotated map 110. As discussed below, the annotated map 110 includes a lane boundary model.

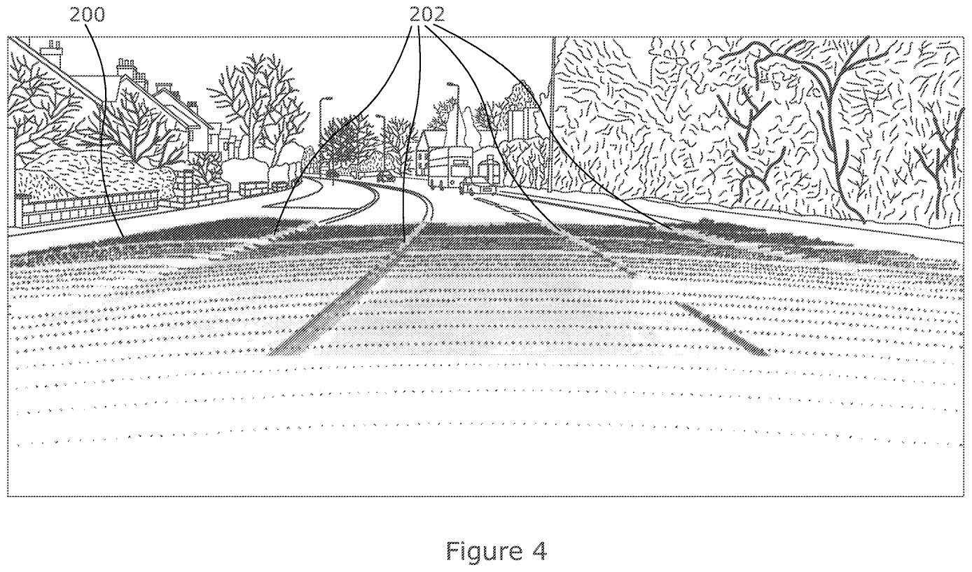

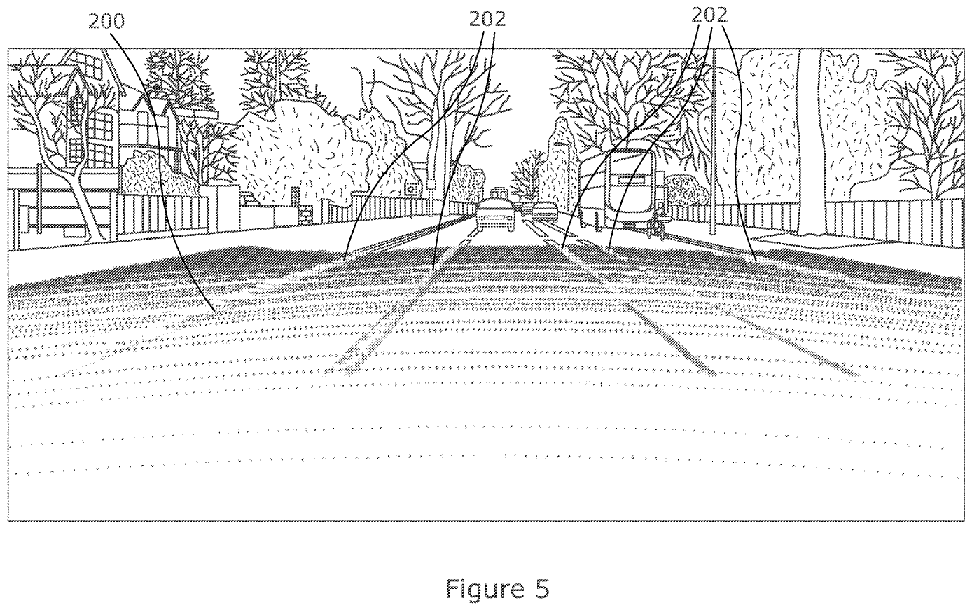

With reference to FIG. 4, a three-dimensional LiDAR point cloud of the lane boundary 202 may be constructed by selecting a plurality of points from the integrated three-dimensional point cloud of the route 200 that correspond positionally to the identified lane boundary. Because the image used to derive the lane boundary using the machine learning model and the LiDAR are paired, points in the three-dimensional point cloud of the route that correspond positionally with the lane boundary can be selected as the three-dimensional LiDAR point cloud of the lane boundary 202. FIG. 5 shows the same method of constructing a three-dimensional point cloud of the lane boundary 202 but for a different route.

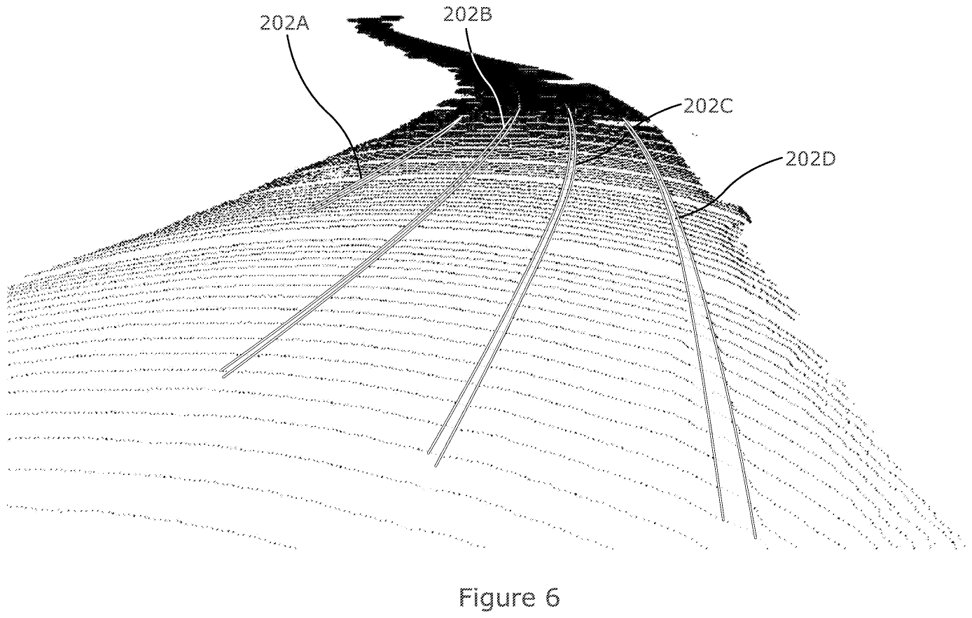

With reference to FIG. 6, a plurality of points from the three-dimensional point cloud of the lane boundaries are clustered into a cluster 202A-D for each specific lane boundary. In FIG. 6, there are four lane boundaries, and thus four clusters 202A-D. The clustering of the points into a cluster is performed using a distance between points. More specifically, the distances between points may be distances between each point and each respective adjacent point. A plurality of the points are clustered into a cluster if the respective distance is less than a distance threshold. the distance threshold is weighted according to a direction to the respective adjacent point.

The distance threshold is weighted to increase towards a first direction and decrease towards a second direction. The first direction may be parallel to the direction of travel of the autonomous vehicle and the second direction may be perpendicular to the direction of travel of the autonomous vehicle.

For example, a first point is selected. Points adjacent to the first point are identified. A distance is measured between the first point and each of the identified adjacent points. The distances are derivable from the positional information of the LiDAR scans. The distances may be real-world distances.

A distance threshold may be weighted to increase non-linearly. For example, in plan view, the distance threshold may look elliptical. For example, if a first adjacent points is Xmm from the first point in a longitudinal direction of travel of the AV and a second adjacent point is also Xmm from the first point in a transverse direction of travel of the AV, the first adjacent point may be within the distance threshold boundary but the second adjacent point may not.

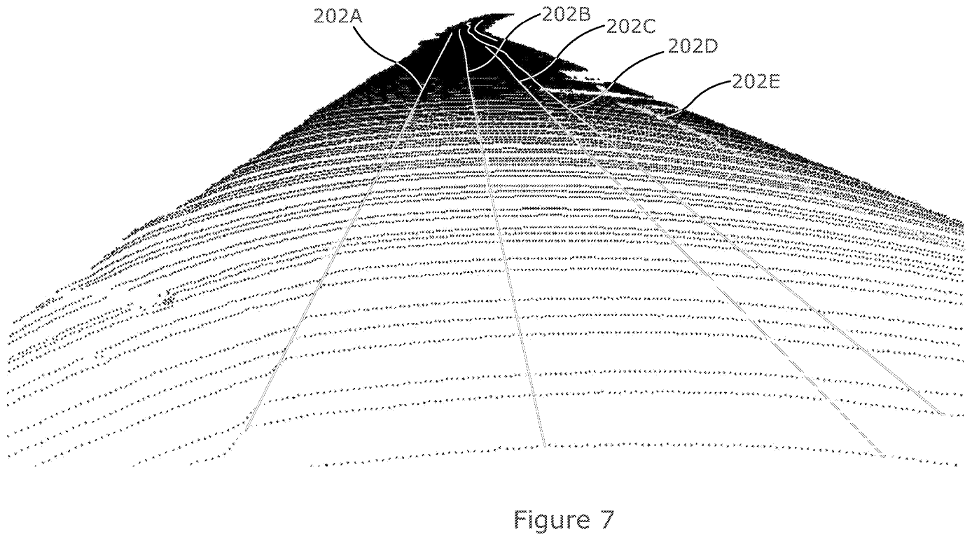

FIG. 7 shows a similar view to FIG. 6 but for clusters obtained for lane boundaries of a different route. In FIG. 7, there are five clusters 202A-E.

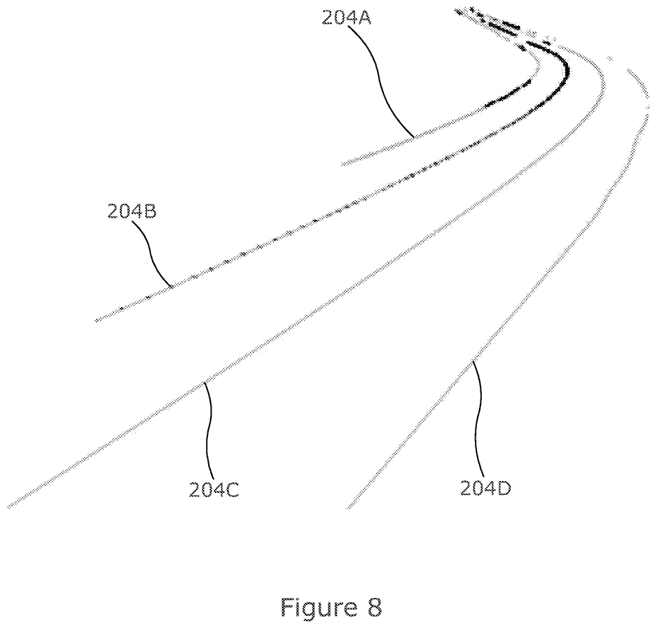

With reference to FIG. 8, a spline of best fit is then constructed for each cluster using a spline generating algorithm. To construct the spline of best fit, first a random set of points from the plurality of points in the cluster is iteratively selected. There may be 103 iterations. For example, there may be around 2000 iterations. In each iteration, a different set of points is randomly selected. Then, a spline of best fit is constructed for each set.

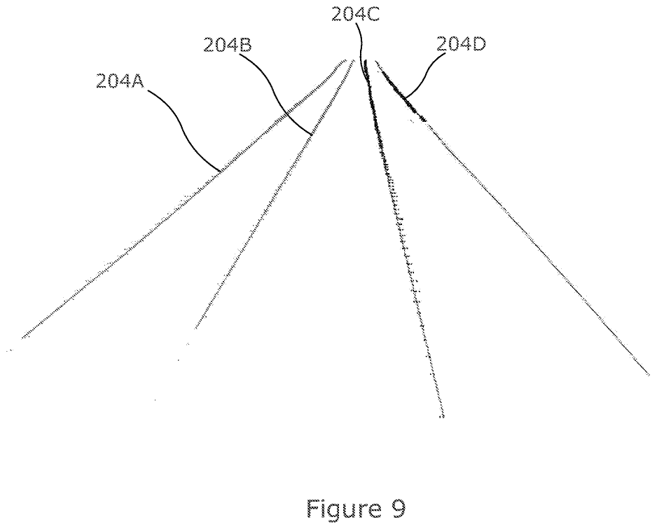

Next, a distance of the spline of best fit to points in the set is calculated. The distance may be an aggregate distance or a mean distance. For example, a unit distance between each point in the set and the spline may be calculated. These unit distances may be the smallest distances between each point and the spline. In other words, a closest point of the spline to the respective point is used to measure the unit distance. The aggregate distance is obtained by adding all unit distances together. The mean distance is obtained by taking the aggregate distance and dividing by the number of points within the set. The spline of best fit with the smallest distance is selected as the spline of best fit 204A-D for the cluster. All of the splines of best fit 204A-D for an image may be combined to form a lane boundary model. FIG. 9 shows a similar view of FIG. 8, and the same method has been used for a different route.

With further reference to FIG. 2, as explained above, at 108, the three-dimensional LiDAR point cloud of the route (the map) is annotated with the lane boundary model to form an annotated map 110.

The method may also comprise a computer-implemented method of generating training data for training a machine learning model to detect automatically a lane boundary from an image of a route traversed by an autonomous vehicle.

At step 112, the lane boundary model is projected, from the three-dimensional LiDAR point cloud of the route (the map) onto a plurality of traversals of the route. The term “traversal” is used herein to mean a different journey along the same route. The lane boundary model should be valid for all traversals but certain sections of the lane boundary may be occluded because of objects appearing along the route in some traversals but not others. Dynamic objects in particular may be different between traversals.

Therefore, at step 114, one or more sections of the lane boundary, or lane boundaries, may be removed to delete the occluded sections of the lane boundary. The one or more sections of the lane boundary are removed automatically.

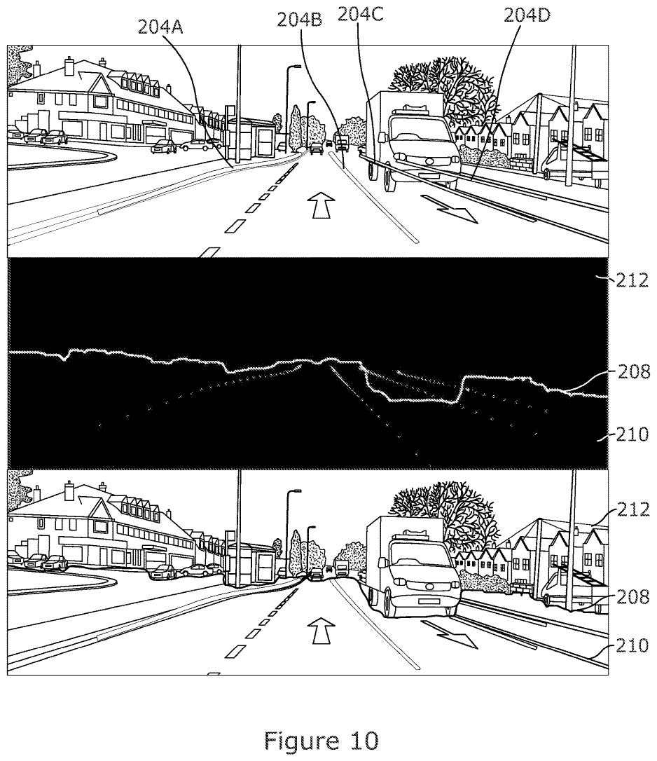

With reference to FIG. 10, the automatic removal of the one or more sections of the lane boundary may comprise generating a free space model, using a further machine learning model, from the image. The free space model includes one or more free space regions and one or more occluded regions. The further machine learning model may comprise a neural network. The neural network may be a convolutional neural network.

The further machine learning model has been trained initially with manually annotated free space boundaries and image pairs. The boundary 208 separates the one or more free space regions 210 and the one or more occluded regions 212. The further machine learning model is thus trained to generate a free space boundary 208 between the one or more free space regions 210 and the one or more occluded regions 212.

With reference to FIGS. 2 and 10, the method at step 114 may then include deleting one or more sections of the lane boundary overlapping the one or more occluded regions, and retaining the one or more sections of the lane boundary overlapping the one or more free space regions. The method thus generates an occlusionless lane boundary in the form of a ground truth 116, which includes only the retained one or more sections of the lane boundary or boundaries. In addition, a training example 118 is generated which includes the image annotated with the occlusionless lane boundary. At step 120, the raw image of the traversal and the image annotated with the occlusionless lane boundary may be used as training pairs to train the machine learning model 102.

With further reference to FIG. 2, at step 122, as explained above, the images of the route may be manually annotated to train initially the machine learning model 102.

At step 124, the method may comprise capturing a new image by the AV 10 during a different traversal of the route. There is no need at this stage to capture the LiDAR data as the point cloud is not needed at inference time.

At step 126, inference is performed, using the machine learning model 102, on the new image to identify a new lane boundary. The new lane boundary is shown at 128.

The new lane boundary 128 may be compared to the ground truth 116, at step 130 to evaluate the performance of the machine learning model 102. An accuracy score of the new lane boundary may be determined based on the comparison. In more detail, the accuracy score may be determined in one or more of the following ways. In other words, the accuracy score may be the equivalent of any of a precision score, a recall score, or an F1 score. A precision score may be determined based on the comparison. A recall score may be determined based on the comparison. An F1 score may be determined based on the comparison.

The foregoing scores are calculated using different formulae using false negative, FN, and false positive, FP, true negative, TN, and true positive, TP, results from the comparison. Those different formulae may be the following.

Accuracy score=(TP+TN)/(TP+FP+FN+TN)

Simply put, the accuracy score is a ratio of correctly predicted observations to the total observations.

Precision score=TP/(TP+FP)

The precision score is thus the ratio of correctly predicted positive observations to the total predicted positive observations.

Recall score=TP/(TP+FN)

The recall score is thus the ratio of correctly predicted positive observations to all the observations in the actual class.

F1 score=2×(Recall score×Precision score)/(Recall score+Precision score)

The F1 score is thus the weighted average of the Precision score and the Recall score.

At step 130, if the accuracy score is greater than or equal to an accuracy threshold, the machine learning model 102 is considered to have made an accurate prediction. In other words, the machine learning model is considered to be accurate. If the accuracy score is less than the accuracy threshold, the machine learning model 102 is considered not to have made an accurate prediction. In other words, the machine learning model is considered not to be accurate.

If the machine learning model 102 is considered not to have made an accurate prediction, step 112 is repeated using the new image as the image during a further iteration of the method and the lane boundary model is projected onto the new image 124. Steps 114, 118, and 120, may then be performed so the machine learning model 102 accuracy can be improved for traversal from which the new image was taken. A new ground truth may be generated at 116 for the new image.

In summary of the above, with reference to FIG. 11, there is provided a computer-implemented method of generating training data for training a machine learning model to detect automatically a lane boundary from an image of a route traversed by an autonomous vehicle, the computer-implemented method comprising: obtaining S300 an image captured by an autonomous vehicle during a traversal of the route; projecting S302 a lane boundary model, from a three-dimensional LiDAR point cloud of the route, on to the image; and generating S304 a training data example for training the machine learning model by removing automatically one or more sections of the lane boundary corresponding to one or more respective occlusions in the image.

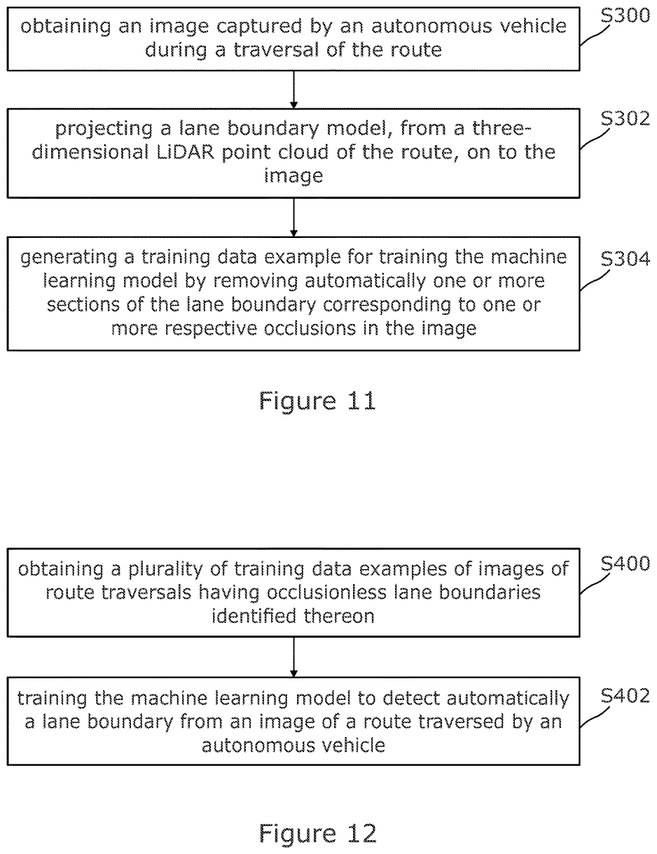

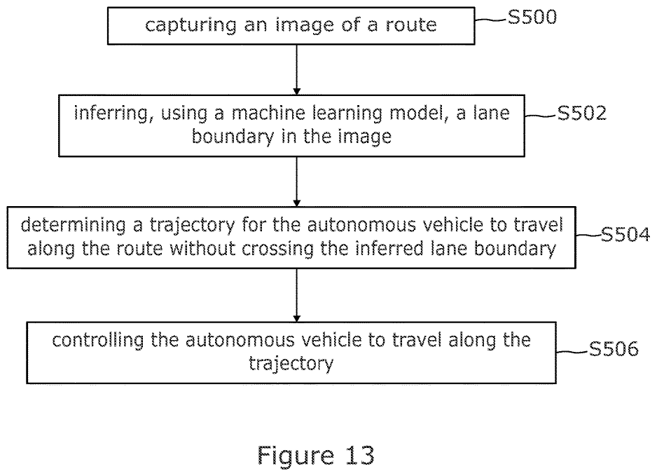

In addition, with reference to FIG. 12, there is provided a computer-implemented method of computer-implemented method of training a machine learning model to detect automatically a lane boundary from an image of a route traversed by an autonomous vehicle, the computer-implemented method comprising: obtaining S400 a plurality of training data examples of images of route traversals having occlusionless lane boundaries identified thereon; and training S402 the machine learning model to detect automatically a lane boundary from an image of a route traversed by an autonomous vehicle.

The same method using steps 124, 126, and 128, and optionally, 130, and 132, may be used at run-time. In this way, the method is above to control the vehicle to traverse the route. In order words, with reference to FIG. 10 according to one or more embodiments, there is provided a computer-implemented method of determining a trajectory for an autonomous vehicle to traverse without crossing a detected lane boundary of a route, the method comprising: capturing S500 an image of a route; inferring S502, using a machine learning model, a lane boundary in the image; determining S504 a trajectory for the autonomous vehicle to travel along the route without crossing the inferred lane boundary; and controlling S506 the autonomous vehicle to travel along the trajectory. The machine learning model may be the machine learning model 102 from FIG. 2.

Whilst the foregoing embodiments have been described to illustrate the subject-matter of the present disclosure, the features of the embodiments are not to be taken as limiting the scope of protection. For the avoidance of doubt, the scope of protection is defined by the following claims.

One or more clauses are included below that provide information related to the subject-matter of the present disclosure.

### Clauses

Clause 1. A computer-implemented method of generating a lane boundary model of a route traversed by an autonomous vehicle, the computer-implemented method comprising: obtaining a three-dimensional LiDAR point cloud of a route and an image of the route traversed by the autonomous vehicle; detecting, using a machine learning model, a lane boundary in the image of the route; and generating a lane boundary model based on a plurality of points of the three-dimensional LiDAR point cloud of the route that correspond positionally with the detected lane boundary.

Clause 2. The computer-implemented method of Clause 1, wherein the obtaining the three-dimensional LiDAR point cloud of the route comprises: capturing, by the autonomous vehicle, a plurality of LiDAR points of the route; and integrating the plurality of LiDAR points to generate the three-dimensional point cloud of the route.

Clause 3. The computer-implemented method of Clause 2, wherein the plurality of LiDAR points and the image are paired.

Clause 4. The computer-implemented method of any preceding clause, wherein the obtaining the image of the route comprises: capturing, by the autonomous vehicle, the image of the route.

Clause 5. The computer-implemented method of any preceding clause, wherein the generating the lane boundary model based on the plurality of points of the three-dimensional LiDAR point cloud of the route that correspond positionally with the detected lane boundary comprises: constructing a three-dimensional point cloud of the lane boundary by selecting a plurality of points that correspond positionally to the identified lane boundary from the integrated three-dimensional point cloud; clustering a plurality of points from three-dimensional point cloud of the lane boundary into one or more clusters using a distance between points; and constructing a spline or best fit for each cluster as the lane boundary model.

Clause 6. The computer-implemented method of Clause 5, wherein the distance between the points is calculated by: determining a distance between each point and each respective adjacent point; and clustering the plurality of points into the cluster if the respective distance is less than a distance threshold.

Clause 7. The computer-implemented method of Clause 6, wherein the distance threshold is weighted according to a direction to the respective adjacent point.

Clause 8. The computer-implemented method of Clause 7, wherein the distance threshold is weighted to increase towards a first direction and decrease towards a second direction, wherein the first direction is parallel to the direction of travel of the autonomous vehicle and the second direction is perpendicular to the direction of travel of the autonomous vehicle.

Clause 9. The computer-implemented method of any of Clauses 5 to 8, wherein constructing the spline of best fit comprises: iteratively selecting a random set of points from the plurality of points in the cluster; constructing a spline of best fit for each iteratively selected set; calculating, for each set, a distance of the spline of best fit, to points in the set; and selecting a spline of best fit with the smallest distance as the spline of best fit for the cluster.

Clause 10. The computer-implemented method of Clause 9, wherein the distance is an aggregate distance.

Clause 11. The computer-implemented method of Clause 9, wherein the distance is a mean distance.

Clause 12. The computer-implemented method of any preceding clause, wherein the machine learning model comprises a neural network.

Clause 13. The computer-implemented method of Clause 12, wherein the neural network is a convolutional neural network.

Clause 14. A transitory or non-transitory computer-readable medium, including instructions stored thereon that when executed by a processor, cause the processor to perform the method of any preceding clause.

Clause 15. An autonomous vehicle including the transitory computer-readable medium of Clause 14.

1. A computer-implemented method of generating training data for training a machine learning model to detect automatically a lane boundary from an image of a route traversed by an autonomous vehicle, the computer-implemented method comprising:
obtaining an image captured by an autonomous vehicle during a traversal of the route;
projecting a lane boundary model, from a three-dimensional LiDAR point cloud of the route, on to the image; and
generating a training data example for training the machine learning model by removing automatically one or more sections of the lane boundary corresponding to one or more respective occlusions in the image.

2. The computer-implemented method of claim 1, wherein the removing automatically one or more sections of the lane boundary comprises:
generating a free space model, using a further machine learning model, from the image, wherein the free space model includes one or more free space regions and one or more occluded regions;
deleting one or more sections of the lane boundary overlapping the one or more occluded regions; and
retaining one or more sections of the lane boundary overlapping the one or more free space regions.

3. The computer-implemented method of claim 2, further comprising:
generating a ground truth including the retained one or more sections of the lane boundary.

4. The computer-implemented method of claim 2 or claim 3, wherein the further machine learning model comprises a neural network.

5. The computer-implemented method of claim 4, wherein the neural network is a convolutional neural network.

6. The computer-implemented method of any preceding claim, further comprising:
obtaining a new image captured by an autonomous vehicle during a different traversal of the route; and
performing inference, using the machine learning model, on the new image to determine a new lane boundary.

7. The computer-implemented method of claim 6, when dependent upon claim 3, further comprising:
comparing the new lane boundary to the ground truth; and
determining an accuracy score of the new lane boundary based on the comparison.

8. The computer-implemented method of claim 7, wherein the determining the accuracy score may be determined as one or more of:
a precision score based on the comparison; and/or
a recall score based on the comparison; and/or
an f1 score based on the comparison.

9. The computer-implemented method of claim 7 or claim 8, further comprising:
determining that the machine learning model is accurate if the accuracy score is greater than or equal to an accuracy threshold; and
determining that the machine learning model is not accurate if the accuracy score is less than the accuracy threshold.

10. The computer-implemented method of claim 9, wherein, when the machine learning model is determined not to be accurate, the computer-implemented method further comprises:
repeating, using the new image as the image, the:
projecting the lane boundary model, from the three-dimensional LiDAR point cloud of the route, on to the image; and
generating a training data example for training the machine learning model by removing automatically one or more sections of the lane boundary corresponding to one or more respective occlusions in the image.

11. The computer-implemented method of any preceding claim, further comprising:
obtaining, by the autonomous vehicle, a plurality of LiDAR points of the route; and
integrating the plurality of LiDAR points to generate a three-dimensional point cloud of the route.

12. The computer-implemented method of claim 11, wherein the plurality of LiDAR points and the image are paired.

13. The computer-implemented method of claim 11 or claim 12, further comprising:
identifying, using the machine learning algorithm, a lane boundary from the captured image;
constructing a three-dimensional point cloud of the lane boundary by selecting a plurality of points that correspond positionally to the identified lane boundary from the integrated three-dimensional point cloud;
clustering a plurality of points from three-dimensional point cloud of the lane boundary into one or more clusters using a distance between points; and
constructing a spline or best fit for each cluster as the lane boundary model.

14. The computer-implemented method of claim 13, wherein the distance between points is calculated by:
determining a distance between each point and each respective adjacent point; and
clustering the plurality of points into the cluster if the respective distance is less than a distance threshold.

15. The computer-implemented method of claim 14, wherein the distance threshold is weighted according to a direction to the respective adjacent point.

16. The computer implemented-method of claim 15, wherein the distance threshold is weighted to increase towards a first direction and decrease towards a second direction, wherein the first direction is parallel to the direction of travel of the autonomous vehicle and the second direction is perpendicular to the direction of travel of the autonomous vehicle.

17. The computer-implemented method of any of claims 13 to 16, wherein constructing the spline of best fit comprises:
iteratively selecting a random set of points from the plurality of points in the cluster;
constructing a spline of best fit for each iteratively selected set;
calculating, for each set, a distance of the spline of best fit, to points in the set; and
selecting a spline of best fit with the smallest distance as the spline of best fit for the cluster.

18. The computer-implemented method of claim 17, wherein the distance is an aggregate distance.

19. The computer-implemented method of claim 17, wherein the distance is a mean distance.

20. The computer-implemented method of any preceding claim, wherein the machine learning model comprises a neural network.

21. The computer-implemented method of claim 20, wherein the neural network is a convolutional neural network.

22. A computer-implemented method of training a machine learning model to detect automatically a lane boundary from an image of a route traversed by an autonomous vehicle, the computer-implemented method comprising:
obtaining a plurality of training data examples of images of route traversals having occlusionless lane boundaries identified thereon; and
training the machine learning model to detect automatically a lane boundary from an image of a route traversed by an autonomous vehicle.

23. The computer-implemented method of claim 22, wherein the obtaining the plurality of training data examples comprises the computer-implemented method of any of claims 1 to 20.

24. A transitory or non-transitory computer-readable medium, including instructions stored thereon that when executed by a processor, cause the processor to perform the method of any preceding claim.

25. An autonomous vehicle comprising the non-transitory computer-readable medium of claim 24.
